(19) United States
(12) Patent Application Publication
(10) Pub. No.: US 2008/0280117 A1
(43) Pub. Date: Nov. 13, 2008

(54) Coextruded Blown Films of Polylactide and Polyolefins

(76) Inventors: Robert Knoll, Neenah, WI (US); Brian Muehl, Neenah, WI (US); Michael Stecker, Neenah, WI (US)

Correspondence Address: BANNER & WITCOFF, LTD., 1100 13th STREET, N.W., SUITE 1200, WASHINGTON, DC, 20005-4051, US

(21) Appl. No.: 12/045,115

(22) Filed: Mar. 10, 2008

Related U.S. Application Data
(60) Provisional application No. 60/894,112, filed on Mar. 9, 2007.

(51) Int. Cl. B32B 27/08; B32B 27/32; B32B 27/36; B29C 47/06

(52) U.S. Cl. 428/216; 428/483; 264/173.14

(57) ABSTRACT

Coextruded blown films comprising coextruded layers of polylactic acid bioresin and polyolefins. Also, a method for making the coextruded blown films.

### FIELD OF THE INVENTION

The invention is related to coextruded blown films. In particular, the invention relates to coextruded blown films comprising coextruded layers of polylactic acid bioresin and polyolefins. The invention also relates to a method for making the coextruded blown films.

### BACKGROUND OF THE INVENTION

Polymeric films are used in many packaging applications. Polyethylene films of various types are well known, as are polypropylene films and other polyolefinic films. Other resin types, such as (meth)acrylates, also are used to form films for packaging applications. These films can be manufactured in accordance with many methods, and often are blown. Blown films have mechanical and performance advantages typically engendered by the orientation of molecules during the blowing process.

Typical polymeric films are hydrocarbon products often derived from petroleum resources. Therefore, the cost of such films may be dependent on the cost of petroleum hydrocarbons. Also, such films may be considered environmentally unfriendly. Some films are recyclable, and advances are being made on this aspect of conserving resources. However, many consumers object to such products in view of the perceived burden these products place on the environment.

Such films often are lacking in some aspect of performance. For example, some films do not provide suitable moisture barrier or resistance to pressure. Films that are not transparent may be rejected by consumers who want clear packaging. Other films may not be sufficiently flexible.

In view of the perceived shortcomings of hydrocarbon films, attempts have been made to produce films that are bio-renewable, such as soy-based products. Also, bioresins such as polylactic acid (PLA) have been formed as films. However, although such bio-renewable products are desirable with regard to the ability to replace the resource, they often exhibit shortcomings. For example, such products often are not durable, and may be degraded by exposure to light and other environmental forces. Similarly, the resultant films often exhibit unsatisfactory performance. For example, PLA film is stiff and brittle, and exhibits high moisture permeability. Therefore, it is unsatisfactory for many packaging applications.

Therefore, combination films often are used in such packaging applications. Whereas many satisfactory films containing hydrocarbon-based films have been developed, these films are burdened with all the objections to single hydrocarbon-based films because these laminated products remain hydrocarbon based.

In view of the objections to packaging products made solely from petroleum hydrocarbon resources, it would be preferable to produce a laminate film product that contains a bio-renewable resin, or a bioresin. However, to include such a bioresin in a laminate with petroleum hydrocarbon films has not been attainable in a commercially practical product.

Therefore, there exists a need for a packaging film product that comprises bioresin-based film.

### BRIEF SUMMARY OF THE INVENTION

A first embodiment is directed to a coextruded blown film comprising polylactide and polyolefins.

A second embodiment is directed to a coextruded blown film comprising polylactide bonded to polyolefin with an appropriate coextruded tie resin.

### DETAILED DESCRIPTION OF THE INVENTION

The invention is directed in one embodiment to a coextruded blown film comprising PLA and polyolefin. In particular, an embodiment of the invention is directed to a coextruded blown film comprising PLA bonded to polyolefin with an appropriate adhesive. The adhesive serves to bond the PLA layer to the polyolefin layer. The resultant coextruded blown film is a tough film product having suitable physical properties needed for packaging foods with moderate to long shelf life requirements. In another embodiment, the PLA comprises an additive that improves the appearance, mechanical, and surface properties of the PLA.

In one embodiment, the invention comprises a three-layer coextruded blown film. One layer is PLA film, another layer is a polyolefin film, and the third layer is a tie adhesive that bonds the PLA film to the polyolefin film. The resultant coextruded blown film is a packaging film that possesses physical properties and characteristics needed for packaging food with moderate to long shelf life requirements. In addition, the resultant product comprises renewable bioresin, thus reducing the burden on the environment. The resultant coextruded blown film has better mechanical and moisture barrier properties than PLA alone.

The PLA layer comprises PLA to which additives and modifiers can be added. Additives and modifiers include softeners, plasticizers, tougheners, dyes, and those additives and modifiers known to skilled practitioners and suitably used in PLA. These additives and modifiers are used typically to improve the appearance, mechanical, and surface properties of the PLA film. PLA is commercially available for a number of sources, including Nature Works. PLA resin available from Nature Works under the designator 4032-D is suitably used to form coextruded blown film. The PLA layer typically comprises at least about 80 weight percent PLA, and is between about 80 and about 100 weight percent PLA. PLA concentrations between these values are also typical.

PLA is known to be stiff and brittle. In one embodiment, the PLA layer comprises an ethylene copolymer resin to increase toughness and make the PLA layer more flexible, less stiff, and less brittle. One such ethylene copolymer resin is available from DuPont under the identifier Biomax® XEP-1483. This product is a purified version of DuPont's Biomax® Strong 100 ethylene acrylate copolymer resin and is suitable for use in food packaging. Introduction of this ethylene copolymer resin makes the PLA more flexible and tougher, making the properties and characteristics of the PLA more like those of polyethylene. In particular, this ethylene copolymer resin reduces ‘dead fold,’ known to skilled practitioners as the tendency to form a crease when the film is bent or folded. The concentration of ethylene acrylate is up to 20 weight percent, more typically between about 0.10 and about 15 weight percent, and even more typically between about 0.25 and about 5 weight percent, based on the total weight of PLA and ethylene copolymer.

Another suitable additive is an ethylene/methylacrylate copolymer. This copolymer imparts similar flexibility and toughness to the PLA layer when present in a concentration between about 1 and about 20 weight percent, and more typically between about 1.5 and about 10 weight percent, based on the total weight of PLA and copolymer.

Another layer of the co-extruded blown film comprises polyolefin or a blend of polyolefin appropriate for formation of a coextruded blown film. This layer can be a single layer of polyolefin, or can be a laminate comprising plural layers of polyolefins and other films. The polyolefins include but are not limited to polyethylene, low density polyethylene (LDPE), linear low density polyethylene (LLDPE), and polypropylene. Other layers can comprise other resins. With the guidance provided herein, the skilled practitioner will be able to identify suitable layers comprising polyolefin. Multi-layer films comprising polyolefin are bonded to the PLA layer at a polyolefin layer.

The polyolefin-comprising layer provides desirable mechanical and moisture barrier properties. The layer also may contain additives and modifiers that improve the appearance, mechanical, or surface properties and characteristics of the layer. Skilled practitioners recognize suitable additives and modifiers for such films. These additives and modifiers include but are not limited to slip, anti-block, processing aids, colorants, and the like. Typically, such additives and modifiers are present at a concentration of less than about 5 weight percent.

The adhesive layer comprises a tie adhesive that serves to bond the dissimilar PLA and polyolefin layers. Skilled practitioners recognize that it is difficult to adhere PLA to other resins. In one embodiment of this invention, the tie resin is an anhydride modified ethylene elastomer-based adhesive resin. Such a resin is commercially available from Mitsui Chemicals America, Inc., under the identifier SF600.

Coextruded blown film comprising PLA bioresin, tie adhesive, and polyolefin as described in the various embodiments herein is produced in any method known to the skilled practitioner to produce coextruded blown film comprising PLA bioresin, anhydride modified ethylene elastomer-based adhesive resin, and polyolefin resin. The layer of tie adhesive is coextruded between the PLA layer and the polyolefin layer. Typically, the blown film is formed using conventional co-extruded blown film technology known to the skilled practitioner.

The proportions of the components can be adjusted to provide the properties and characteristics desired of the resultant coextruded blown film. For example, one suitable coextruded blown film comprises about 45 to about 55 wt percent polyolefin (LLDPE), about 5 to about 10 wt percent anhydride modified ethylene elastomer-based adhesive tie resin, and about 35 to about 50 wt percent PLA bioresin. Other suitable coextruded blown films can have different relative proportions of each layer. With the guidance provided herein, the skilled practitioner can determine suitable proportions of the layers.

The skilled practitioner recognizes that the thickness of the layers also can be adjusted to provide a coextruded blown film having desired properties and characteristics. Typically, the thickness of the PLA layer is between about 0.1 and about 2 mils and the thickness of the polyolefin layer is between about 0.1 and about 3 mils. The thickness of the adhesive resin layer, if present, is between about 0.1 and about 1.5 mils. In one embodiment, the caliber or thickness of the PLA layer is between about 0.4 and about 0.6 mil, the layer of the anhydride modified ethylene elastomer-based adhesive tie resin is between about 0.1 and about 0.2 mil thick, if present, and the polyolefin layer is LLDPE having a thickness of between about 0.7 and 0.9 mil. The skilled practitioner recognizes that with the guidance provided herein, these thicknesses can be adjusted to obtain coextruded blown film having particular properties and characteristics. For example, the skilled practitioner recognizes that a multi-layer polyolefin-containing film may be thicker than the values presented herein.

The coextruded blown film produced in accordance with the embodiments of the invention contains some renewable content afforded by the PLA layer, yet has significantly improved overall film properties compared with mono layer PLA film, including for example MVTR, pliability, modulus, cost, and processability as compared with PLA alone. The coextruded blown film is printable and has good moisture barrier properties.

Plural coextruded blown films, each comprising a PLA layer, a tie adhesive layer, and a polyolefin layer that may comprise plural layers, can be ‘self-laminated,’ r laminated or adhered to each other. In one embodiment, the PLA layer of one coextruded blown film is adhered to the polyolefin layer of the other coextruded blown film. In another embodiment, the PLA layer of each film is laminated to the PLA layer of the other film.

In an embodiment wherein the PLA layer of one coextruded blown film is adhered to the polyolefin layer of the other coextruded blown film, an anhydride modified ethylene elastomer-based adhesive tie resin is used. The same resin used to form the coextruded blown film also is used to form the laminate of two coextruded blown films in accordance with this embodiment.

In an embodiment wherein the PLA layers of two coextruded blown films are adhered to each other, a polyether urethane in conjunction with a co-reactant is suitably used. One such adhesive is Adcote™ PLA-SB adhesive and CR SB-PLA co-reactant available from Rohm & Haas. This product is known as an adhesive system for PLA-film. This and other adhesives for PLA are suitably used.

### EXAMPLE 1

Coextruded blown film was produced by coextruding the following three layers:

| | | |
|---|---|---|
| 1. | PLA (Nature Works 4032-D) | 90 wt percent |
| | DuPont Biomax ® XEP-1483 Additive | 10 wt percent |
| 2. | Mitsui SF600 anhydride modified ethylene | 100 wt percent |
| | elastomer-based adhesive tie resin | |
| 3. | Dow 2256G LLDPE comprising | 100 wt percent |
| | 3 wt percent extrusion aide | |

The layers were present in the proportions summarized in the table below, and formed a coextruded blown film having a thickness, or caliper, of 1.5 mil.

| Layer | Wt percent of web | Caliper (mil) |
|---|---|---|
| 1 | 41.5 | 0.53 |
| 2 | 8.7 | 0.15 |
| 3 | 49.8 | 0.83 |

The resultant coextruded blown film comprising three layers exhibits suitable moisture barrier, translucency, toughness and resistance to “dead fold”.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

1. A coextruded blown film comprising a PLA layer and polyolefin layer.

2. The coextruded blown film of claim 1, wherein the PLA layer is adhered to a polyolefin layer with an adhesive layer.

3. The coextruded blown film of claim 1, wherein PLA layer comprises at least about 80 weight percent PLA.

4. The coextruded blown film of claim 1, wherein the PLA layer further comprises an ethylene acrylate copolymer resin.

5. The coextruded blown film of claim 1, wherein the PLA layer further comprises an ethylene/methylacrylate copolymer resin.

6. The coextruded blown film of claim 1, wherein the polyolefin is selected from the group consisting of polyethylene, low density polyethylene (LDPE), linear LDPE (LLDPE), polypropylene and blends thereof.

7. The coextruded blown film of claim 2, wherein adhesive tie layer comprises an anhydride modified ethylene elastomer-based adhesive resin.

8. The coextruded blown film of claim 2, wherein the blown film comprises between about 45 and 55 weight percent polyolefin, between about 5 and about 10 weight percent anhydride modified ethylene elastomer-based adhesive resin, and between about 35 and about 50 weight percent PLA bioresin layer.

9. The coextruded blown film of claim 1, wherein the thickness of the PLA layer is between about 0.1 and about 2 mils, and the thickness of the polyolefin layer is between about 0.1 and about 3 mils.

10. The coextruded blown film of claim 2, wherein the thickness of the PLA layer is between about 0.1 and 2 mils, the thickness of the polyolefin layer is between about 0.1 and about 3 mils, and the thickness of the adhesive resin layer is between about 0.1 and 1.5 mils.

11. The coextruded blown film of claim 1 further comprising another coextruded blown film adhered thereto.

12. The coextruded blown film of claim 11 wherein the PLA layer of a first film is adhered to the PLA layer of a second film.

13. The coextruded blown film of claim 11, wherein the PLA layer of a first film is adhered to the polyolefin layer of a second film with an anhydride modified ethylene elastomer-based adhesive resin.

14. The coextruded blown film of claim 12, wherein the layers are adhered with a polyether urethane adhesive system.

15. A method for making a coextruded blown film comprising PLA and polyolefin, said method comprising coextruding PLA and polyolefin with an anhydride modified ethylene elastomer-based adhesive tie resin therebetween.
